(19) United States
(12) Patent Application Publication
(10) Pub. No.: US 2016/0134720 A1
(43) Pub. Date: May 12, 2016

(54) USING DATA FROM SOCIAL NETWORKS TO BUILD ACCOUNT HOLDER PROFILES

(71) Applicant: MasterCard International Incorporated, Purchase, NY (US)

(72) Inventors: Sebastien POCHIC, Schaerbeek (BE); Lukas Ekselius, Overijse (BE); Fikret Ates, Namur (BE)

(73) Assignee: MASTERCARD INTERNATIONAL INCORPORATED, Purchase, NY (US)

(21) Appl. No.: 14/539,311

(22) Filed: Nov. 12, 2014

(51) Int. Cl. H04L 29/08; G06Q 20/40; G06Q 30/02

(52) U.S. Cl. CPC H04L 67/306; G06Q 30/0269; G06Q 20/4016; H04L 67/22; G06Q 50/01

(57) ABSTRACT

The present disclosure relates to a computer implemented method of building a profile for an account holder 101. The method comprises the steps of: accessing, by a computer, information from one or more social networking accounts 103, the social networking accounts being associated with the account holder; incorporating, by a computer, the information into the profile of the account holder 101; and utilising the information when determining, by a computer, at least one of: a risk score of a transaction, targeted special offers, and targeted goods and services that could be of interest to the account holder.

### FIELD OF THE INVENTION

The present disclosure relates generally, but not exclusively, to account holder profile engines which use information relating to the account holder to build an account holder profile. The account issuer can then use the information comprising the profile to assess the risk of a transaction.

### BACKGROUND TO THE INVENTION

In the competitive and dynamic banking market of today, the relationship a retail bank or indeed any financial institution has with its customers is of the utmost importance. Customers require easy and consistent access to their funds alongside assurances that their funds are secure from any fraudulent activity.

Customer risk assessment plays an important part in helping retail banks ensure that their customer's funds are as readily available to the customer as possible, whilst also ensuring that those funds are not at risk of any fraudulent activity. Know Your Customer (KYC) and Customer Identification Programme (CIP) both outline requirements which many financial institutions (including retail banks) must meet. Both ensure that financial institutions take the appropriate steps to verify the probity and integrity of their customers. The information retained by financial institutions during the KYC and CIP due diligence activities is often used in customer risk assessment. The due diligence activities provide information which can help financial institutions define customer types; specifically identifying customer types conventionally associated with heightened risk.

As part of the KYC process, when a customer opens a new account, the financial institution often estimates expected or anticipated transaction volumes/amounts for that customer. This information can then be included in an initial risk profile for that customer by the financial institution. Once the customer has held an account with the financial institution for a period of time, historical transaction activity can also be factored into the customer's risk profile.

Financial institutions can also include information such as average transaction volumes for customers of the same type as the customer who is opening/holding an account with the financial institution. Customer types may be defined by details about the customer that the financial institution has obtained during the KYC and CIP due diligence processes.

Alternatively, the financial institution may place a new account holder in a probationary high risk category. Subsequently, the financial institution may build a risk profile for the customer over a period of time, amending the risk profile of the customer as an appropriate amount of historical transaction activity is gathered.

Such risk profile generating and customer risk categorising procedures are effective when a customer's transaction activity remains within the limits of their average transaction activity. However, when a customer exceeds the limits of their average transaction activity it is common for customers to have transaction requests rejected, for example, where a large transaction request has been made or where a customer has requested a transaction in a foreign country. This can lead to frustration on the part of the customer, who will often have to telephone the account providing financial institution, in some instances from another country, to confirm that it is they who are wishing to perform the transaction, verifying that the transaction is not a fraudulent transaction.

As such, there is a need to provide an improved means for creating and maintaining an account holder's risk profile such that abnormal transactions can be anticipated and, where appropriate, accommodated.

### SUMMARY OF THE INVENTION

According to a first aspect of the disclosure, there is provided a computer implemented method of building a profile for an account holder, the method comprising: accessing, by a computer, information from one or more social networking accounts, the social networking accounts being associated with the account holder; incorporating, by a computer, the information into the profile of the account holder; and utilising the information when determining, by a computer, at least one of: a risk score of a transaction; targeted special offers; and targeted goods and services that could be of interest to the account holder.

Advantageously, the computer implemented method of the present disclosure provides a profile of an account holder which contains details which would not be available through conventional and existing means and which could be used by, for example, an account issuer, a merchant or a service provider.

Typically, the profile of the account holder is a risk profile.

Typically, the targeted special offers are at least one of: rebates; discounts; and access to special events which are sent to the account holder either before, during or after a transaction.

Typically, at least part of the information comprises geo-location information associated with the account holder.

Advantageously, such information would provide a useful indication of the whereabouts of the account holder. Such information would be useful in many scenarios, for example, the geo-location information may be used in risk profiling to corroborate transaction data where a card associated with an account holder has been or is being used for a transaction at a specific geographical location.

Typically, the geo-location information comprises at least one of information retrieved from posted images, status updates and check-ins associated with the account holder.

Typically, the information is used to establish one or more of the account holder's past, current and future locations.

Typically, at least part of the information comprises at least one of: liked pages, followed companies and mentions associated with the account holder.

Typically, the information is used to infer spending preferences of the account holder.

Advantageously, this provides additional information which could be used to assess whether a purchase or transaction made using the account holder's account corresponds with their inferred spending habits.

Typically, the information is automatically accessed, by a computer, and is publicly available.

Typically, the information is accessed, by a computer, once the account holder has taken steps to make the information accessible to the computer.

Typically, the account holder makes the information accessible to the computer by installing an application within one or more of the social networking accounts.

Typically, the account holder makes the information accessible to the computer by accessing an application external of the social networking accounts and subsequently accessing one or more of the social networking accounts via the application.

Typically, a financial institution is the provider of the application.

Typically, the information is used to determine a risk score of a transaction and either accept or decline said transaction based upon said risk score.

According to a second aspect of the invention, there is provided a server comprising processing and operating means with executable instructions which on execution cause the server to perform the method as set out in the first aspect of the invention, wherein the method may include any of the additional optional features detailed above.

According to a third aspect of the invention, there is provided a computer readable medium for a server comprising computer executable instructions which on execution cause the server to perform the method as set out in the first aspect of the invention, wherein the method may include any of the additional optional features detailed above.

According to a fourth aspect of the invention, there is provided a computer program configured to: access data associated with one or more social networking accounts, the social networking accounts being associated with an account holder; extract data relevant to the generation of at least one of: a risk score of a transaction, targeted special offers and targeted goods and services that could be of interest to the account holder; and forward the extracted data to one of more of: an account holder profile engine; a fraud detection engine; a loyalty engine; and a cross-selling engine.

Typically, the computer program is an application programming interface (API).

### BRIEF DESCRIPTION OF DRAWINGS

Embodiments of the present invention will now be described, by way of example only, with reference to the accompanying drawings, in which:

FIG. 1 shows the parties and exemplary media involved in generating the account holder risk profile of the present invention.

### DETAILED DESCRIPTION

The present invention provides a system which supplements the existing information in a conventional account holder's risk profile with information retrieved from social networking accounts associated with the account holder.

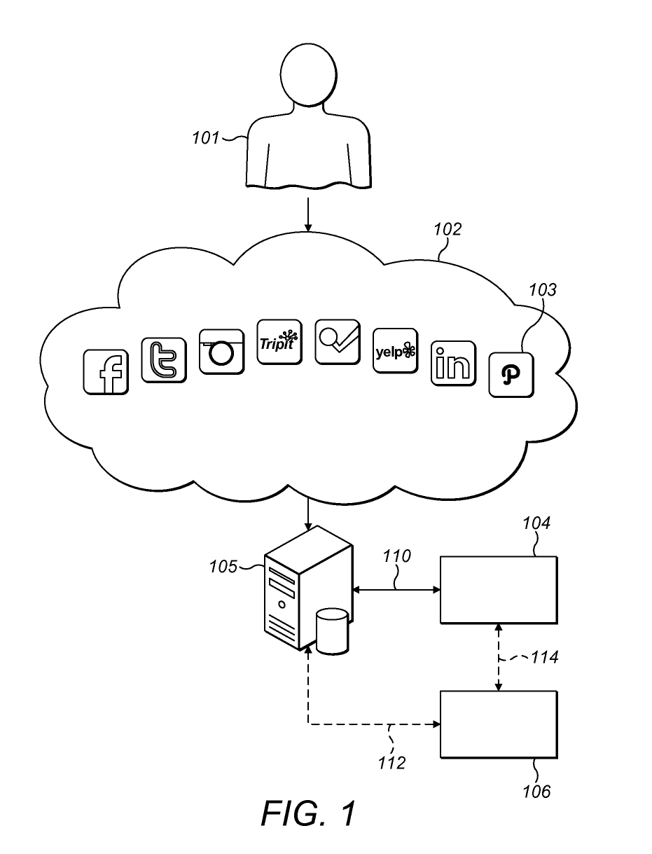

FIG. 1 shows the parties and exemplary media involved in generating the account holder risk profile of the present invention. Depicted are an account holder 101, the Internet 102, digital social media entities 103, for example Facebook™, Twitter™, Instagram™, TripIt™ etc., associated with the account holder, a financial institution 104 which has provided the account holder with an account and an account holder profile engine 105.

The system operates by connecting the account holder's digital social media entities 103 with the account holder profile engine 105 via the Internet 102. The account holder profile engine 105 may be a server operated by the financial institution 104 which issued the account holder 101 with an account, as shown by the solid-lined data flow 110 in FIG. 1. Alternatively, the profile engine 105 may be operated/managed on behalf of the financial institution 104 by a service provider 106, as illustrated by the data flows 112, 114 in dashed lines. Information is the transferred by the digital social media entities 103 to the account holder profile engine 105. This information is then added to the risk profile associated with the account holder.

In order for the information to be transferred from the digital social media entities 103 to the account holder profile engine 105, the account holder 101 may be required to take steps to make the information accessible.

The steps may involve the account holder agreeing to share information when interacting with the financial institution 104 via one or more digital social media entities 103. Such an interaction may involve installing an application within one or more of the digital social media entities 103. The account holder may be required to ‘like’, ‘friend’ or ‘follow’ (these are terms commonly used in social media to denote actions by the user of said media; any appropriate actions which provide access to the user's personal information are envisaged) a profile associated with the financial institution 104 within one or more of the digital social media entities 103.

The steps may involve accessing an application external of the digital social media entities 103, which is associated with the financial institution 104, and the account holder 101 may grant access to the account holder's digital social media entities 103 within the application.

Preferably, the service provided by the system of the present invention requires the account holder to actively opt-in to the service before any information is transferred from the digital social media entities 103 to the account holder profile engine 105.

Alternatively, the account holder profile engine 105 may access the information automatically. This would be appropriate where the information is publically available or has been made publically available by the account holder 101.

The information may be geo-location information retrieved from posted images, status updates, ‘check-ins’, etc. associated with the account holder 101 and which can be used to retrieve information about the account holder's past, current, and/or future location.

The information may be pages ‘liked’, companies ‘followed’, ‘mentions’ made, etc. by and/or relating to the account holder 101. Such information can be used to make inferences about the account holder 101, such as shopping preferences, and past and/or current spending habits, using suitably constructed algorithms.

The information may relate to future intentions of the account holder 101. For example, if an account holder has indicated that they ‘will attend this event’ and/or has added a date to their calendar, possibly also with information of travel plans, etc., then such information can be transmitted to and/or gathered by the account holder profile engine 105.

The information may also be a combination of any of the aforementioned exemplary information types. Any of the information may also originate from third parties, but is related to the account holder.

Once the information has been transmitted/collected, the account holder profile engine 105 processes and incorporates the information into an account holder profile. This step can involve combining the information with conventional risk profile data, such as the aforementioned data obtained during the KYC and CIP due diligence processes and/or historical transaction data where available.

In processing the information, the account holder profile engine 105 may process all the data and metadata obtained which relates to the account holder 101 to maintain an accurate profile consisting of both confirmed facts and inferred information.

A fraud detection engine (not shown) can use the information contained within the account holder's profile to assess the risk of a transaction either during or after a transaction authorization process. The fraud detection engine may also utilise any appropriate known risk assessment techniques in conjunction with the information contained within the accountholder's profile. Transactions may be either allowed or rejected on the basis of information generated by the fraud detection engine.

A loyalty engine (not shown) can use the information contained in the account holder's profile to propose targeted special offers, rebates, discounts, access to special events, etc. For example, any geo-location information contained in the account holder's profile may be used to identify special offers available near any locations identified in the geo-location information. Any targeted special offers may subsequently be transmitted to the account holder via the Internet 102 and, optionally, through the digital social media entities 103.

Any proposals of targeted special offers, rebates, discounts, access to special events, etc. may be made before, during or after a transaction process.

Any of the accountholder's shopping preferences, and past and/or current spending habits identified in the information stored in the account holder's profile may be used to propose targeted special offers, rebates, discounts, access to special events, etc. This information may also be combined with any geo-location information contained in the account holder's profile to propose targeted special offers, rebates, discounts, access to special events, etc.

A cross-selling engine (not shown) can use the information contained in the account holder's profile to present targeted goods and services that could be of interest to the account holder. For example, any of the accountholder's shopping preferences, and past and/or current spending habits identified in the information stored in the account holder's profile may be used to identify goods or services potentially of interest to the account holder. Any identified goods or services may also be transmitted to the account holder via the Internet 102 and, optionally, through the digital social media entities 103.

Any presentations of targeted goods and services that could be of interest to the account holder may be made before, during or after a transaction process.

Geo-location information may also be used to identify goods or services available near any locations identified in the geo-location information. This information may also be combined with any shopping preferences, and past and/or current spending habits identified in the information stored in the account holder's profile to present targeted goods and services that could be of interest to the account holder

In an exemplary scenario, a cardholder uses his card in a foreign country for the first time. Using only the cardholder's transaction history, a traditional fraud detection system might consider this transaction as being ‘high risk’. However, the cardholder has posted a picture on Instagram™ with embedded location information and has checked-in a hotel on Foursquare™. The system of the present invention can use this information to ascertain that the cardholder has travelled to that location and is able to decrease the risk profile of the transaction accordingly.

In a further exemplary scenario, a cardholder uses his card to book a hotel in a foreign country. However, the cardholder is confirmed to be in his home country because of other transactions at physical POS and ATM locations. Information about future travel plans received from the cardholder's TripIt™ calendar feed has enabled the system of the present invention to recognize this transaction as being part of travel preparations and hence decrease its risk profile.

In both of the above exemplary scenarios, the financial institution can, for example, make a determination not to reject a transaction from a locale that the account holder intends to travel to on and/or around a specified date based on the social media feeds.

It will be understood that the terms, ‘social media accounts’, ‘digital social media entities’, ‘social media entities’, ‘social networking accounts’, used herein, are interchangeable. All terms commonly used to describe social media accounts are also interchangeable with the terms used herein.

The Figures and descriptions thereof herein should not be understood to prescribe a fixed order of performing the method steps described therein. Rather, the method steps may be performed in any order that is practicable. Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

1. A computer implemented method of building a profile for an account holder, the method comprising:
accessing, by a computer, information from one or more social networking accounts, the social networking accounts being associated with the account holder;
incorporating, by a computer, the information into the profile of the account holder; and
utilising the information when determining, by a computer, at least one of: a risk score of a transaction; targeted special offers; and targeted goods and services that could be of interest to the account holder.

2. The method of claim 1, wherein the profile of the account holder is a risk profile.

3. The method of claim 1, wherein the targeted special offers are at least one of: rebates; discounts; and access to special events which are sent to the account holder either before, during or after a transaction.

4. The method of claim 1, wherein at least part of the information comprises geo-location information associated with the account holder.

5. The method of claim 1, wherein the geo-location information comprises at least one of information retrieved from posted images, status updates and check-ins associated with the account holder.

6. The method of claim 1, wherein the information is used to establish one or more of the account holder's past, current and future locations.

7. The method of claim 1, wherein at least part of the information comprises at least one of: liked pages, followed companies and mentions associated with the account holder.

8. The method of claim 7, wherein the information is used to infer spending preferences of the account holder.

9. The method of claim 1, wherein the information is automatically accessed, by a computer, and is publicly available.

10. The method of claim 1, wherein the information is accessed, by a computer, once the account holder has taken steps to make the information accessible to the computer.

11. The method of claim 10, wherein the account holder makes the information accessible to the computer by installing an application within one or more of the social networking accounts.

12. The method of claim 10, wherein the account holder makes the information accessible to the computer by accessing an application external of the social networking accounts and subsequently accessing one or more of the social networking accounts via the application.

13. The method of claim 11, wherein a financial institution is the provider of the application.

14. The method of claim 12, wherein a financial institution is the provider of the application.

15. The method of claim 1, wherein the information is used to determine a risk score of a transaction and either accept or decline said transaction based upon said risk score.

16. A server comprising processing and operating means with executable instructions which on execution cause the server to perform the method as set out in claim 1.

17. A computer readable medium for a server comprising computer executable instructions which on execution cause the server to perform the method as set out in claim 1.

18. A computer program configured to, when executed in a computer:
access data associated with one or more social networking accounts, the social networking accounts being associated with an account holder;
extract data relevant to the generation of at least one of: a risk score of a transaction, targeted special offers and targeted goods and services that could be of interest to the account holder; and
forward the extracted data to one of more of: an account holder profile engine; a fraud detection engine; a loyalty engine; and a cross-selling engine.

19. The computer program of claim 18, wherein the computer program is an application programming interface (API).
